(19) United States
(12) Patent Application Publication
(10) Pub. No.: US 2012/0115043 A1
(43) Pub. Date: May 10, 2012

(54) NONAQUEOUS ELECTROLYTE SECONDARY BATTERY

(75) Inventors: Denis Yau Wai YU, Singapore (SG); Katsunori Yanagida, Kobe-shi (JP); Hidekazu Yamamoto, Kobe-shi (JP)

(73) Assignee: SANYO ELECTRIC CO., LTD., Osaka (JP)

(21) Appl. No.: 13/292,574

(22) Filed: Nov. 9, 2011

(30) Foreign Application Priority Data
Nov. 9, 2010 (JP) 2010-251064

(51) Int. Cl. H01M 10/056; H01M 4/505

(52) U.S. Cl. 429/332; 429/338

(57) ABSTRACT

A nonaqueous electrolyte secondary battery includes a positive electrode containing a positive electrode active material, a negative electrode containing a negative electrode active material, and a nonaqueous electrolyte solution containing a nonaqueous solvent. The positive electrode active material contains a lithium-containing transition metal oxide represented by general formula (1), Li₁₊ₓMn_{y}M_{z}O₂ (where x, y, and z satisfy 0<x<0.4, 0<y<1, 0<z<1, and x+y+z=1; and M represents at least one metal element and contains at least one of Ni and Co). The nonaqueous solvent contains a fluorinated cyclic carbonate having two or more fluorine atoms directly bonded to a carbonate ring.

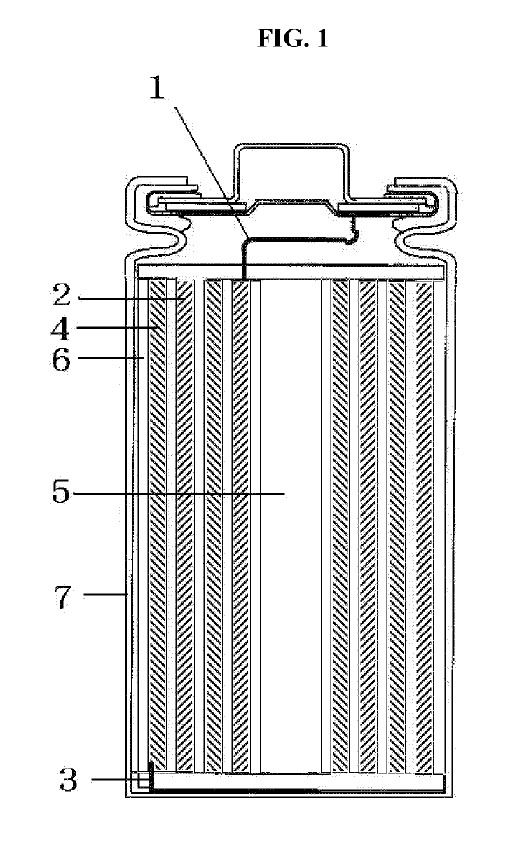

### CROSS REFERENCE TO RELATED APPLICATIONS

The present invention application claims priority to Japanese Patent Application No. 2010-251064 filed in the Japan Patent Office on Nov. 9, 2010, the entire contents of which are incorporated herein by reference.

### BACKGROUND OF THE INVENTION

1. Field of the Invention

The present invention relates to nonaqueous electrolyte secondary batteries.

2. Description of Related Art

Power consumption of portable electric devices has been on the increase in recent years. Nonaqueous electrolyte secondary batteries used as the power sources of these devices are also increasingly required to achieve higher capacities.

Lithium-containing layered oxides such as LiCoO₂, LiNiO₂, and LiNi_{1/3}Mn_{1/3}Co_{1/3}O₂ have been studied to date as a positive electrode active material for a nonaqueous electrolyte secondary battery. However, for example, when Li₁₋ₐCoO₂ is used, its crystal structure collapses when charging is conducted until a 0.6. Thus, a high positive electrode potential range remains unused and it has been difficult to increase the capacity. There has been the same problem with other positive electrode active materials.

In contrast, lithium-excess transition metal oxides such as Li₂MnO₃(Li[Li_{1/3}Mn_{2/3}]O₂) and solid solutions thereof have a layered structure as with LiCoO₂, and contain lithium in transition metal layers as well as a lithium layer. Thus lithium-excess transition metal oxides contain a larger amount Li contributing to charging and discharging and have drawn much attention as prospective positive electrode materials that can help achieve high capacities (U.S. Pat. No. 6,677,082 (Patent Document 1)).

However, nonaqueous electrolyte secondary batteries that use lithium-excess transition metal oxides as a positive electrode active material rarely achieve high cycle characteristics, which has been a problem.

### BRIEF SUMMARY OF THE INVENTION

An object of the present invention is to provide a nonaqueous electrolyte secondary battery that has high capacities and good cycle characteristics.

A nonaqueous electrolyte secondary battery according to an embodiment of the present invention includes a positive electrode containing a positive electrode active material, a negative electrode containing a negative electrode active material, and a nonaqueous electrolyte solution containing a nonaqueous solvent. The positive electrode active material contains a lithium-containing transition metal oxide represented by general formula (1), Li₁₊ₓMn_{y}M_{z}O₂ (where x, y, and z satisfy 0<x<0.4, 0<y<1, 0<z<1, and x+y+z=1; and M represents at least one metal element and contains at least one of Ni and Co). The nonaqueous solvent contains a fluorinated cyclic carbonate having two or more fluorine atoms directly bonded to a carbonate ring.

According to this structure, a coating film is formed on a surface of the positive electrode active material. Thus, the reaction between the positive electrode active material and the electrolyte solution can be suppressed and the cycle characteristics can thereby be improved.

In general formula (1), x preferably satisfies 0.12<x<0.40, y preferably satisfies 0.4<y<1, and z preferably satisfies 0<z<0.6.

The lithium-containing transition metal oxide is preferably represented by general formula (2) Li₁₊ₓMn_{y}Ni_{z1}Co_{z2}O₂ (where x, y, z1, and z2 satisfy 0<x<0.4, 0.4<y<1, 023 z1<0.4., 0≦z2<0.4, 0<z1+z2, and x+y+z1+z2=1). In particular, when z2 is within the above-described range, generation of gas caused by the reaction between the positive electrode active material and the fluorinated cyclic carbonate is suppressed.

The fluorinated cyclic carbonate content is preferably 5% to 50% by volume and more preferably 10% to 40% by volume relative to the total amount of the nonaqueous electrolyte solution. When the fluorinated cyclic carbonate content is smaller than the above-described range, the effect of suppressing the reaction between the positive electrode active material and the electrolyte solution is diminished. In contrast, when the fluorinated cyclic carbonate content is larger than the above-described range, the coating film formed on the negative electrode becomes too thick and the effect of improving cycle characteristics is diminished.

The fluorinated cyclic carbonate may be a single fluorinated cyclic carbonate or two or more fluorinated cyclic carbonates used in combination. At least one of the fluorinated cyclic carbonates is preferably difluoroethylene carbonate and more preferably 4,5-difluoroethylene carbonate. 4,5-Difluoroethylene carbonate has a cis isomer and a trans isomer and either isomer may be used.

The nonaqueous solvent preferably further contains at least one of ethyl methyl carbonate, 2,2,2-trifluoroethyl methyl carbonate, or methyl 3,3,3-trifluoropropionate.

When a boron-containing oxide and/or a boron-containing hydroxide adhere to surfaces of particles of the positive electrode active material, decomposition of the electrolyte solution is suppressed at a high charging voltage. As a result, the cycle characteristics are further improved.

The lower limit of the amount of the boron-containing oxide, the boron-containing hydroxide, or both relative to the total amount of the positive electrode active material is preferably 0.05% by mass or more and more preferably 0.1% by mass or more. The upper limit is preferably 5% by mass or less and more preferably 3% by mass or less. When the adhered amount is less than the lower limit, the effect of further improving the cycle characteristics is diminished. When the adhered amount is more than the upper limit, the effect of increasing the capacity is diminished.

As for the form of adhesion, the boron-containing oxide or boron-containing hydroxide having a protruding shape is preferably evenly dispersed and adhered to surfaces of the lithium-containing transition metal oxide. The lithium-containing transition metal oxide preferably contains a structure that belongs to space group C2/m or C2/c. The lithium-containing transition metal oxide preferably further contains a structure that belongs to space group R-3m.

The negative electrode active material preferably contains silicon since not only the battery capacity per unit volume is increased compared to carbon negative electrodes of related art but also generation of gas caused by a reaction between the negative electrode and the fluorinated cyclic carbonate can be suppressed.

The potential of the positive electrode is preferably 4.5 V or more on a metallic lithium basis since the battery capacity per unit mass and per unit volume is increased. The potential of the positive electrode is more preferably 4.7 V or more on a metallic lithium basis to further increase the battery capacity. Although the upper limit for the potential of the positive electrode is not particularly set, the upper limit is preferably 5.0 V or less. This is because an excessively high potential induces decomposition of the electrolyte solution and other problems.

In synthesizing the lithium-containing transition metal oxide, a method usually employed for synthesizing a lithium-containing transition metal oxide, such as a solid phase method, can be employed. For example, the lithium-containing transition metal oxide can be synthesized by mixing a lithium salt, a manganese salt, a cobalt salt, and a nickel salt with one another at a particular molar ratio and firing the resulting mixture at 700° C. to 900° C.

The negative electrode active material is preferably a material that can occlude and release lithium. Examples thereof include lithium, silicon, lithium alloys, carbonaceous materials, and metal compounds. These negative electrode active materials may be used alone or in combination.

Examples of the lithium alloys include a lithium aluminum alloy, a lithium silicon alloy, a lithium tin alloy, and a lithium magnesium alloy. Examples of the carbonaceous materials include natural graphite, synthetic graphite, coke, vapor-grown carbon fibers, mesophase-pitch-based carbon fibers, spherical carbon, and resin-baked carbon.

Each of the positive electrode active material and the negative electrode active material may be mixed with a conducting agent and a binder and used as a mix. A conductive aunt is not needed when the conductivity of the active material is high. A conductive agent is preferably mixed when the conductivity of the active material is low. The conductive agent may be any material having conductivity and may be at least one selected from oxides, carbides, nitrides, and carbon materials having high conductivity. Examples of the oxides include tin oxide and indium oxide. Examples of the carbides include tungsten carbide and zirconium carbide. Examples of the nitrides include titanium nitride and tantalum nitride.

When the amount of the conductive agent mixed is excessively small, the conductivity of the mix may become insufficient. In contrast, when the amount of conductive agent mixed is excessively large, the fraction of the active material in the mix is decreased and a high energy density may not be achieved. Accordingly, the amount of the conductive agent is preferably more than 0% by mass and 30% by mass or less, more preferably 1% by mass or more and 20% by mass or less, and most preferably 2% by mass or more and 10% by mass or less relative to the total amount of the active material.

Examples of the binder include polytetrafluoroethylene, polyvinylidene fluoride, polyethylene oxide, polyvinyl acetate, polymethacrylate, polyacrylate, polyacrylonitrile, polyvinyl alcohol, styrene-butadiene rubber, and carboxymethyl cellulose.

When the amount of the binder mixed is excessively small, the contact between the mix and the collector may become insufficient. When the amount of the binder mixed is excessively large, the fraction of the active material in the mix is decreased and a high energy density may not be obtained. Accordingly, the amount of binder relative to the total amount of the active material is preferably more than 0% by mass or more and 30% by mass or less, more preferably 1% by mass or more and 20% by mass or less, and most preferably 2% by mass or more and 10% by mass or less.

Examples of the fluorinated cyclic carbonate include 4,5-difluoroethylene carbonate, 4,4-difluoroethylene carbonate, 4,4,5-trifluoroethylene carbonate, and 4,4,5,5-tetrafluoroethylene carbonate.

The nonaqueous solvent may further contain a cyclic carbonate ester, a linear carbonate ester, an ester, a cyclic ether, a linear ether, a nitrile, and/or an amide.

Examples of the cyclic carbonate include ethylene carbonate, propylene carbonate, and butylene carbonate. Some or all of the hydrogen atoms of these compounds may be fluorinated.

Examples of the linear carbonate ester include dimethyl carbonate, ethyl methyl carbonate, diethyl carbonate, methyl propyl carbonate, ethyl propyl carbonate, and methyl isopropyl carbonate. Some or all of the hydrogen atoms of these linear carbonate esters may be fluorinated.

Examples of the ester include methyl acetate, ethyl acetate, propyl acetate, methyl propionate, ethyl propionate, and γ-butyrolactone.

Examples of the cyclic ether include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and a crown ether.

Examples of the linear ether include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxy toluene, benzyl ethyl ether, diphenyl ether, dibenzyl ether, o-dimethoxy benzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Examples of the nitrile include acetonitrile. Examples of the amide include dimethyl formamide.

These nonaqueous solvents may be used alone or in combination.

The electrolyte added to the nonaqueous solvent can be a lithium salt generally used as the electrolyte in existing nonaqueous electrolyte secondary batteries. Examples thereof include LiPF₆, LiBF₄, LiAsF₆, LiClO₄, LiCF₃SO₃, LiN(FSO₂)₂, LiN(C₁F₂ₗ₊₁SO₂)(CₘF₂ₘ₊₁SO₂) (l and m are each an integer of 1 or more), LiC(CₚF₂ₚ₊₁SO₂)(C_{q}F_{2q+1}SO₂)(CᵣF₂ᵣ₊₁SO₂) (p, q, and r are each an integer of 1 or more), Li[B(C₂O₄)₂](lithium bis(oxalate)borate (LiBOB)), Li[B(C₂O₄)F₂], Li[P(C₂O₄)F₄], and Li[P(C₂O₄)₂F₂]. These lithium salts may be used alone or in combination.

### Nonaqueous Electrolyte Secondary Battery

A nonaqueous electrolyte secondary battery includes a positive electrode active material, a negative electrode active material, a nonaqueous electrolyte solution, and other battery components such as a separator, a battery case, and a collector that supports the active materials and collects power. No particular limitations are imposed on components other than the positive electrode active material and the nonaqueous solvent. Various components known in the art can be freely selected.

The present invention provides a nonaqueous electrolyte secondary battery that has high capacities and excellent cycle characteristics.

### BRIEF DESCRIPTION OF THE SEVERAL VIEWS OF THE DRAWINGS

The FIGURE is a schematic diagram of a battery prepared in Examples and Comparative Examples.

### DETAILED DESCRIPTION OF THE INVENTION

The present invention will now be described in further detail by using examples. The present invention is not limited by the examples described below and modifications and alterations thereof is possible without departing from the scope of the present invention.

### EXAMPLES

### Experiment 1

### Example 1

### Preparation of Positive Electrode

Lithium hydroxide (LiOH) was mixed with Mn_{0.67}Ni_{0.17}Co_{0.17}(OH)₂ prepared by a coprecipitation method so that the stoichiometric ratio of Li_{1.2}Mn_{0.54}Ni_{0.13}Co_{0.13}O₂ was satisfied. The mixed powder was pelletized and fired for 24 hours at 900° C. in air to synthesize a positive electrode active material. The positive electrode active material was dipped in a 1 mass % H₃BO₃ solution, dried in air at 80° C., and fired for 10 hours at 300° C. in air.

The resulting positive electrode active material was analyzed by powder X-ray diffractometry to identify phases. As a result, a mixed phase of a structure belonging to space group R-3m and a structure belonging to space group C2/m was found.

The resulting positive electrode active material, acetylene black, and polyvinylidene fluoride were mixed at a mass ratio of 92:4:4, and N-methyl-2-pyrrolidone (NMP) was added to the mixture to prepare a slurry. The slurry was applied on both sides of a collector composed of an aluminum foil, dried in air at 120° C., rolled, and cut into a particular size. Then a positive electrode tab 1 composed of aluminum was attached to an uncoated part of the electrode to prepare a positive electrode 2 as shown in the FIGURE.

### Preparation of Negative Electrode

Silicon, carbon, and polyimide were mixed at a mass ratio of 86.4:3.6:6.5 and NMP was added to the resulting mixture to prepare a slurry. The slurry was applied on both sides of a collector composed of a copper foil, dried in air at 120° C., and rolled. The resulting electrode was heat-treated for 10 hours at 400° C. in an argon atmosphere. Then the electrode was cut into a particular size and a negative electrode tab 3 composed of nickel was attached to an uncoated portion of the electrode to prepare a negative electrode 4 as shown in the FIGURE.

### Preparation of Nonaqueous Electrolyte Solution

In a nonaqueous solvent prepared by mixing 4,5-difluoroethylene carbonate and ethyl methyl carbonate at a volume ratio of 2:8, 1 mol of LiPF₆ was dissolved per liter to prepare a nonaqueous electrolyte solution 5 as shown in the FIGURE.

### Preparation of Battery

The positive electrode 2 and the negative electrode 4 were wound with a polyethylene separator 6 therebetween and inserted into a battery can 7. The nonaqueous electrolyte solution 5 prepared as above was poured into the battery can 7 and a lid was sealed to prepare a battery A1 shown in the FIGURE.

### Example 2

A battery A2 was prepared as in Example 1 except that the nonaqueous electrolyte solution was prepared by dissolving 1 mol of LiPF₆ per liter of a nonaqueous solvent prepared by mixing 4,5-difluoroethylene carbonate and methyl 3,3,3-trifluoropropionate at a volume ratio of 2:8.

### Comparative Example 1

A battery X1 was prepared as in Example 1 except that the nonaqueous electrolyte solution was prepared by dissolving 1 mol of LiPF₆ per liter of a nonaqueous solvent prepared by mixing 4-fluoroethylene carbonate and ethyl methyl carbonate at a volume ratio of 2:8.

### Evaluation of Cycle Characteristics

Each of the batteries A1, A2, and X1 was charged at a constant current of 0.5 It until the battery voltage was 4.45 V and then charged at a constant voltage of 4.45 V until the current value was 0.05 It. The potential of the positive electrode at this stage was 4.60 V on a metallic lithium basis. Then discharge was conducted at a constant current of 0.5 It until the battery voltage was 1.50 V and the initial discharge capacity Q1 of the battery was measured. Charge-discharge cycles were conducted under the charge/discharge conditions of this experiment and the discharge capacity Q2 of the 100th cycle was measured. The 100th-cycle capacity retaining ratio was determined as the ratio of Q2 to Q1 (Q2/Q1)×100. The results are shown in Table 1.

TABLE 1

| | | Initial | 100th-cycle |
|---|---|---|---|
| | | discharge | capacity |
| | | capacity | retaining |
| | Nonaqueous solvent | (mAh) | ratio (%) |
| Battery A1 | 4,5-Difluoroethylene | 1180 | 76.9 |
| | carbonate/ethyl methyl carbonate | | |
| Battery A2 | 4,5-Difluoroethylene | 1180 | 90.9 |
| | carbonate/methyl 3,3,3- | | |
| | trifluoropropionate | | |
| Battery X1 | 4-Fluoroethylene carbonate/ethyl | 1200 | 0 |
| | methyl carbonate | | |

The results from the batteries A1 and X1 in Table 1 show that adding 4,5-difluoroethylene carbonate to the electrolyte solution significantly improves the cycle characteristics. Although the reason for this is not clear, the following can be presumed. When general formula (1) is satisfied, oxygen is released from the positive electrode active material during initial charging. 4,5-Difluoroethylene carbonate reacts with the oxygen released from the positive electrode active material and forms a coating film on a surface of the positive electrode active material. As a result, the reaction between the positive electrode active material and the electrolyte solution can be suppressed. Presumably, the cycle characteristics of the battery A1 were better than those of the battery X1 since this coating film is more stable than a coating film formed by 4-fluoroethylene carbonate.

The results from the batteries A1 and A2 show that adding methyl 3,3,3-trifluoropropionate to the nonaqueous solvent further improves the cycle characteristics. One of the reasons for this is presumably that the viscosity of methyl 3,3,3-trifluoropropionate is lower than that of ethyl methyl carbonate and thus methyl 3,3,3-trifluoropropionate has a higher penetrability to the mix of the electrolyte solution. Another possible reason is that the oxidation resistance of methyl 3,3,3-trifluoropropionate at a high potential is higher than that of ethyl methyl carbonate.

### Experiment 2

### Example 3

A battery A3 was prepared as in Example 2 except that the composition of the positive electrode active material was changed to Li_{1.04}Mn_{0.32}Co_{0.32}Ni_{0.32}O₂.

### Comparative Example 2

A battery X2 was prepared as in Example 3 except that the nonaqueous electrolyte solution was prepared by dissolving 1 mol of LiPF₆ per liter of a nonaqueous solvent prepared by mixing 4-fluoroethylene carbonate and methyl 3,3,3-trifluoropropionate at a volume ratio of 2:8.

Evaluation of Cycle Characteristics

Each of the batteries A3 and X2 was charged at a constant current of 0.5 It until the battery voltage was 4.45 V and then charged at a constant voltage of 4.45 V until the current value was 0.05 It. The potential of the positive electrode at this stage was 4.60 V on a metallic lithium basis. Then discharge was conducted at a constant current of 0.5 It until the battery voltage was 2.50 V and the initial discharge capacity Q3 of the battery was measured. Charge-discharge cycles were conducted under the charge/discharge conditions of this experiment and the discharge capacity Q4 of the 150th cycle was measured. The 150th-cycle capacity retaining ratio was determined as the ratio of Q4 to Q3 (Q4/Q3)×100. The results are shown in Table 2.

TABLE 2

| | | Initial | 150th-cycle |
|---|---|---|---|
| | | discharge | capacity |
| | | capacity | retaining |
| | Nonaqueous solvent | (mAh) | ratio (%) |
| Battery A3 | 4,5-Difluoroethylene | 1100 | 81.6 |
| | carbonate/methyl 3,3,3- | | |
| | trifluoropropionate | | |
| Battery X2 | 4-Fluoroethylene carbonate/ | 1100 | 32.4 |
| | methyl 3,3,3-trifluoropropionate | | |

The results from the batteries A3 and X2 in Table 2 show that adding 4,5-difluoroethylene carbonate to the electrolyte solution significantly improves the cycle characteristics. The results from the battery A2 in Table 1 and the battery A3 in Table 2 show that the cycle characteristics are further improved when x in general formula (1) satisfies 0.12<x<0.40.

### Experiment 3

### Comparative Example 3

A positive electrode active material, LiCoO₂ was prepared as in Example 1 except that Li₂CO₃ and Co₃O₄ were used. A battery X3 was prepared as in Example 1 except that this positive electrode active material and the following nonaqueous electrolyte solution were used.

### Preparation of Nonaqueous Electrolyte Solution

A nonaqueous electrolyte solution was prepared by dissolving 1 mol of LiPF₆ per liter of a nonaqueous solvent prepared by mixing 4,5-difluoroethylene carbonate and methyl propionate at a volume ratio of 2:8.

### Comparative Example 4

A battery X4 was prepared as in Comparative Example 3 except that the nonaqueous electrolyte solution was prepared by dissolving 1 mol of LiPF₆ per liter of a nonaqueous solvent prepared by mixing 4-fluoroethylene carbonate and methyl propionate at a volume ratio of 2:8.

### Evaluation of Cycle Characteristics

Each of the batteries X3 and X4 was charged at a constant current of 1.0 It until the battery voltage was 4.20 V and then charged at a constant voltage of 4.20 V until the current value was 0.05 It. The potential of the positive electrode at this stage was 4.35 V on a metallic lithium basis. Then discharge was conducted at a constant current of 1.0 It until the battery voltage was 2.75 V and the initial discharge capacity Q5 of the battery was measured. Charge-discharge cycles were conducted under the charge/discharge conditions of this experiment and the discharge capacity Q6 of the 100th cycle was measured. The 100th-cycle capacity retaining ratio was determined as the ratio of Q6 to Q5 (Q6/Q5)×100. The results are shown in Table 3.

TABLE 3

| | | Initial | 100th-cycle |
|---|---|---|---|
| | | discharge | capacity |
| | | capacity | retaining |
| | Nonaqueous solvent | (mAh) | ratio (%) |
| Battery X3 | 4,5-Difluoroethylene | 900 | 77.3 |
| | carbonate/methyl propionate | | |
| Battery X4 | 4-Fluoroethylene carbonate/ | 900 | 74.2 |
| | methyl propionate | | |

The results from the batteries X3 and X4 show that when the positive electrode active material is LiCoO₂, the effect of improving the cycle characteristics achieved by 4,5-difluoroethylene carbonate is not so significant compared to 4-fluoroethylene carbonate. The results from batteries A1 to A3 and X3 show that a high initial discharge capacity can be obtained when general formula (1) is satisfied.

Accordingly, the present invention can provide a nonaqueous electrolyte secondary battery that has high capacities and excellent cycle characteristics.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A nonaqueous electrolyte secondary battery comprising:
a positive electrode containing a positive electrode active material;
a negative electrode containing a negative electrode active material; and
a nonaqueous electrolyte solution containing a nonaqueous solvent,
wherein the positive electrode active material contains a lithium-containing transition metal oxide represented by general formula (1), Li₁₊ₓMn_{y}M_{z}O₂ (where x, y, and z satisfy 0<x<0.4, 0<y<1, 0<z<1, and x+y+z=1; and M represents at least one metal element and contains at least one of Ni and Co), and
the nonaqueous solvent contains a fluorinated cyclic carbonate having two or more fluorine atoms directly bonded to a carbonate ring.

2. The nonaqueous electrolyte secondary battery according to claim 1, wherein x satisfies 0.12<x<0.40.

3. The nonaqueous electrolyte secondary battery according to claim 1. wherein the lithium-containing transition metal oxide is a lithium-containing transition metal oxide represented by general formula (2), Li₁₊ₓMn_{y}Ni_{z1}Co_{z2}O₂ (where x, y, z1, and z2 satisfy 0<x<0.4, 0.4<y<1, 0≦z1<0.4, 0≦z2<0.4, 0<z1+z2, and x+y+z1+z2=1).

4. The nonaqueous electrolyte secondary battery according to claim 1, wherein 10% to 40% by volume of the fluorinated cyclic carbonate is contained relative to the total amount of the nonaqueous electrolyte solution.

5. The nonaqueous electrolyte secondary battery according to claim 2, wherein 10% to 40% by volume of the fluorinated cyclic carbonate is contained relative to the total amount of the nonaqueous electrolyte solution.

6. The nonaqueous electrolyte secondary battery according to claim 3, wherein 10% to 40% by volume of the fluorinated cyclic carbonate is contained relative to the total amount of the nonaqueous electrolyte solution.

7. The nonaqueous electrolyte secondary battery according to claim 1, wherein the fluorinated cyclic carbonate is difluoroethylene carbonate.

8. The nonaqueous electrolyte secondary battery according to claim 2, wherein the fluorinated cyclic carbonate is difluoroethylene carbonate.

9. The nonaqueous electrolyte secondary battery according to claim 3, wherein the fluorinated cyclic carbonate is difluoroethylene carbonate.

10. The nonaqueous electrolyte secondary battery according to claim 4, wherein the fluorinated cyclic carbonate is difluoroethylene carbonate.

11. The nonaqueous electrolyte secondary battery according to claim 5, wherein the fluorinated cyclic carbonate is difluoroethylene carbonate.

12. The nonaqueous electrolyte secondary battery according to claim 6, wherein the fluorinated cyclic carbonate is difluoroethylene carbonate.

13. The nonaqueous electrolyte secondary battery according to claim 1, wherein the nonaqueous solvent further contains at least one of ethyl methyl carbonate, 2,2,2-trifluoroethyl methyl carbonate, and methyl 3,3,3-trifluoropropionate.

14. The nonaqueous electrolyte secondary battery according to claim 1, wherein at least one of a boron-containing oxide and a boron-containing hydroxide is adhered on surfaces of grains of the positive electrode active material.

15. The nonaqueous electrolyte secondary battery according to claim 1, wherein the amount of the at least one of the boron-containing oxide and the boron-containing hydroxide adhered is 0.05% by mass or more and 5% by mass or less relative to the total amount of the positive electrode active material.

16. The nonaqueous electrolyte secondary battery according to claim 1, wherein the lithium-containing transition metal oxide includes a structure that belongs to space group C2/m or C2/c.

17. The nonaqueous electrolyte secondary battery according to claim 3, wherein the lithium-containing transition metal oxide includes a structure that belongs to space group C2/m or C2/c.

18. The nonaqueous electrolyte secondary battery according to claim 1, wherein the lithium-containing transition metal oxide further includes a structure that belongs to space group R-3m.

19. The nonaqueous electrolyte secondary battery according to claim 1, wherein the negative electrode contains silicon.

20. The nonaqueous electrolyte secondary battery according to claim 1, wherein the positive electrode has a potential of 4.5 V or more on a metallic lithium basis.
